(19) United States
(12) Patent Application Publication
(10) Pub. No.: US 2013/0124480 A1
(43) Pub. Date: May 16, 2013

(54) System and Method for Viewer Based Image Metadata Sanitization

(71) Applicants: Clint Chua, Alhambra, CA (US); Matthew Steiner, Los Altos, CA (US); Jonathan Wray, Santa Monica, CA (US)

(72) Inventors: Clint Chua, Alhambra, CA (US); Matthew Steiner, Los Altos, CA (US); Jonathan Wray, Santa Monica, CA (US)

(21) Appl. No.: 13/443,601

(22) Filed: Apr. 10, 2012

Related U.S. Application Data
(60) Provisional application No. 61/559,262, filed on Nov. 14, 2011.

(51) Int. Cl. G06F 7/00; G06F 17/30

(52) U.S. Cl. 707/644; 707/E17.005

(57) ABSTRACT

A request to access a file comprising content and metadata is received. In response to determining the request is from a source other than an owner of the content (or file), a copy of the content is generated and the content's metadata is modified in order to create modified metadata for the copy of the content. A Uniform Resource Locator (URL) that provides access to the copy of the content and the modified metadata is provided to the source of the request. However, in response to determining the request is from the owner of the content, a URL that provides access to the content and the metadata is provided to the owner of the content.

### CROSS-REFERENCE TO RELATED APPLICATION

This application claims the benefit of U.S. Provisional Patent Application No. 61/559,262, filed on Nov. 15, 2011 and entitled “VIEWER-BASED IMAGE METADATA SANITIZATION,” the disclosure of which is hereby incorporated by reference in its entirety.

### TECHNICAL FIELD

This specification relates generally to systems and methods for modifying metadata of multimedia content, and more particularly to systems and methods for modifying metadata in response to a user requesting access to the content.

### BACKGROUND

The increased use of social networking websites has facilitated the growth of user-generated content, including images and photographs, on such websites. Many users place personal photographs and images on their personal web pages, for example. Such user-generated content is commonly accompanied by embedded metadata. Metadata may often include personal or private information regarding the content and/or the user who placed the user-generated content on the social networking website. In many circumstances, other users of the social networking website who access user-generated content can also gain access to the user-generated content's accompanying metadata.

### SUMMARY

In accordance with an embodiment, a method(s) of, system(s) and apparatus for modifying metadata associated with content is provided herein. In one embodiment, a request to access a file comprising content and metadata is received. In response to determining the request is from a source other than an owner of the content (or owner of the file), a copy of the content in the file is generated and the file's metadata is sanitized (i.e. modified) in order to create sanitized metadata (i.e. modified metadata) for the copy of the content. A Uniform Resource Locator (URL) that provides access to the copy of the content and the sanitized metadata is provided to the source of the request. However, in response to determining the request is from the owner of the content, a URL that provides access to the content and the metadata is provided to the owner of the content.

In another embodiment, at least a portion of the metadata of the content is prevented from being included in metadata for the copy of the content.

In one embodiment, the content is an image and at least one geocode in the metadata of the image is prevented from being included in the metadata of the copy of the image.

In one embodiment, the metadata is modified in accordance with a metadata sharing preference specified by the owner of the content.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to modify metadata in accordance with an embodiment;

FIG. 2 shows components of an exemplary user device;

FIG. 3 shows functional components of at least a portion of a website manager in accordance with an embodiment;

FIG. 4 shows a scenario for generating a URL that provides access to the content and the metadata provided to the owner of the content in accordance with an embodiment;

FIG. 5 shows a scenario for generating a URL that provides access to an image copy having modified metadata provided to a source other than the owner of an image in accordance with an embodiment;

FIG. 6 is a flowchart of a method of modifying metadata in accordance with an embodiment;

FIG. 7 shows components of a computer that may be used to implement certain embodiments of the invention.

### DETAILED DESCRIPTION

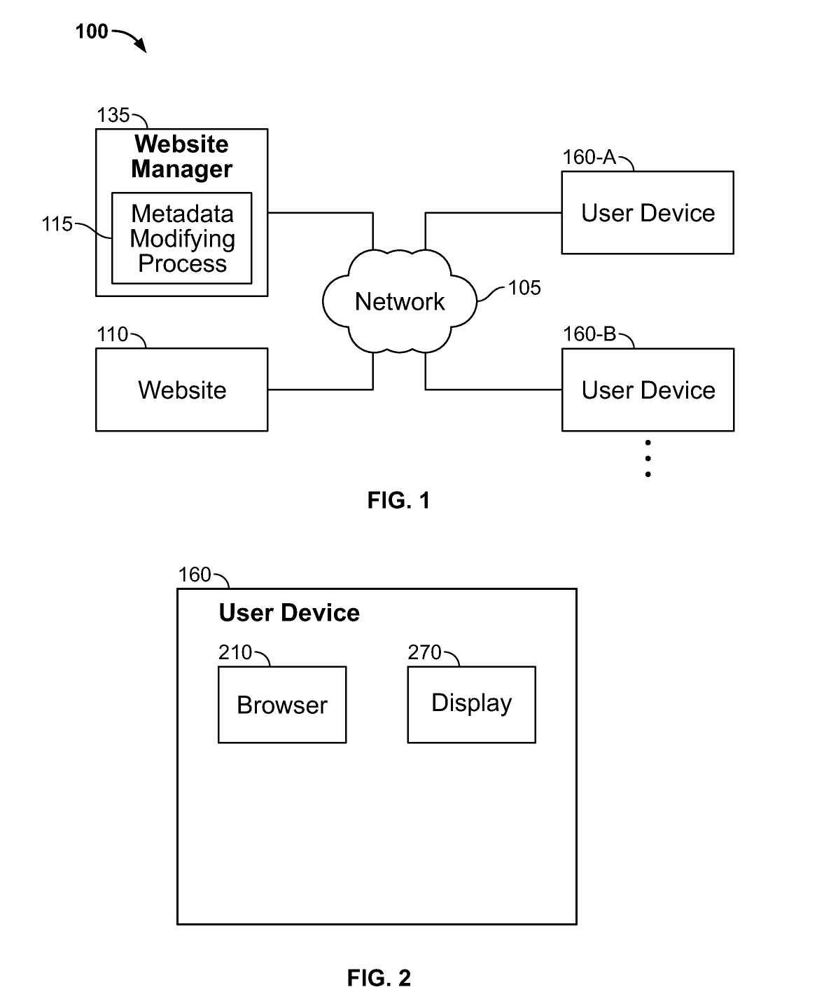

FIG. 1 shows a communication system 100 that may be used to modify metadata in accordance with an embodiment. Communication system 100 includes a website manager 135 including a metadata modifying process 115, as well as a website 110 and several user devices 160-A, 160-B, etc. For convenience, the term “user device 160” is used herein to refer to any one of user devices 160-A, 160-B, etc. Accordingly, any discussion herein referring to “user device 160” may be equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may include one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may include a combination of different types of networks.

Website 110 is a website accessible via network 105. Website 110 comprises one or more web pages containing various types of information, such as articles, comments, images, photographs, etc.

Website manager 135 manages website 110. Website manager 135 accordingly provides to users of user devices 160 access to various web pages of website 110. Website manager 135 also provides other management functions, such as receiving requests, comments, messages, images, and other information from users and posting such information on various web pages of website 110. In addition, metadata modifying process 115 executes within website manager 135 in order to ensure that certain portions of metadata associated with content are not accessible to a user who is not the owner of the content. It is understood that metadata modifying process 115, in various embodiments, need not necessarily be executed within website manager 135. In other embodiments, metadata modifying process 115 may be executed with respect to any computer system(s).

User device 160 may be any device that enables a user to communicate via network 105. User device 160 may be connected to network 105 through a direct (wired) link, or wirelessly. User device 160 may have a display screen (not shown) for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

FIG. 2 shows functional components of an exemplary user device 160 in accordance with an embodiment. User device 160 comprises a web browser 210 and a display 270. Web browser 210 may be a conventional web browser used to access World Wide Web sites via the Internet, for example. Display 270 displays documents, Web pages and other information to a user. For example, a web page containing text, images, etc., may be displayed on display 270.

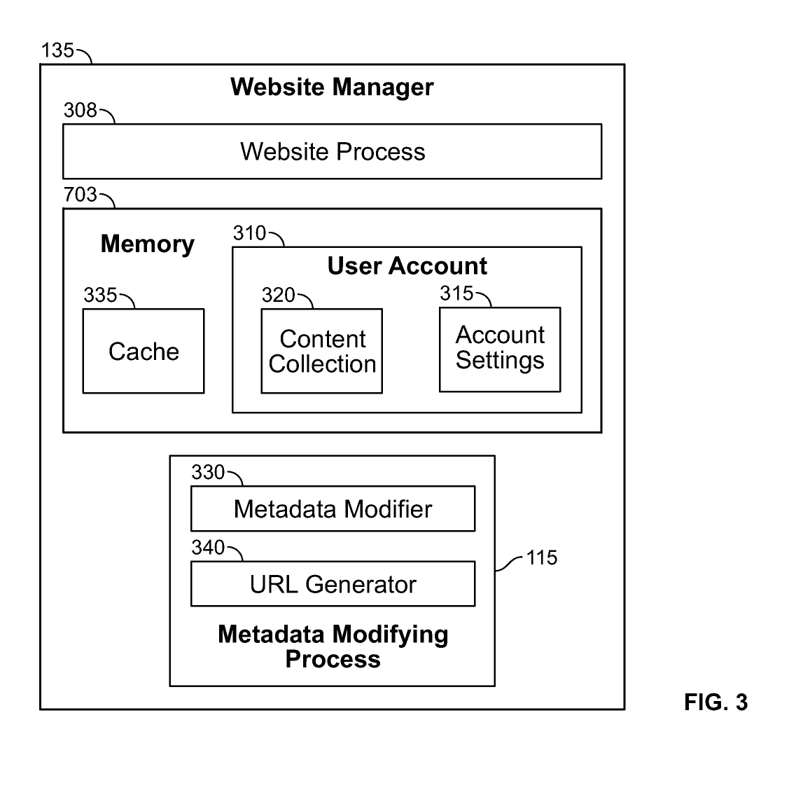

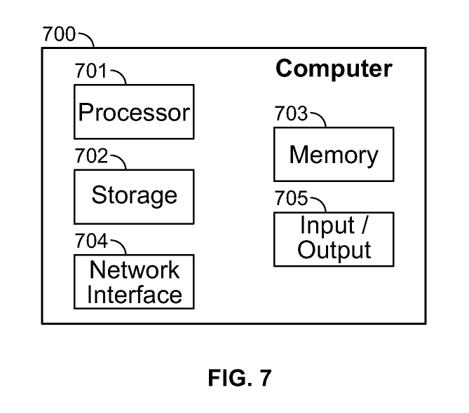

FIG. 3 shows functional components of website manager 135 in accordance with an embodiment. Website manager 135 comprises a website process 308, a memory 703 (and/or storage 702, FIG. 7) which at least includes the metadata modifying process 115, a user account 310, a metadata modifier 330 and a URL generator 340. At least a portion of the memory 703 (and/or storage 702) can also be designated as a cache 335. Website process 308 generates and maintains website 110 and various web pages of website 110. The user account 310 further includes account settings 315 and a content collection 320. In one embodiment, the content collection 320 includes images uploaded to the website 110 from a user device 160 associated with the user account 310. The account settings 315 include account preferences and account characteristics selected by a user(s) associated with the user account 310. It is understood that the content collection 320 can include any kind of content, such a images, video, documents and other forms of digital media.

Website process 308 enables users to access website 110 and various web pages, content and images within the website. For example, website process 308 may receive from a user device 160 a URL associated with a web page of website 110 and direct the user device 160 to the web page. Website process 308 may additionally receive, from a user device 160, a request to view an image included in the content collection 320 associated with the user account 310.

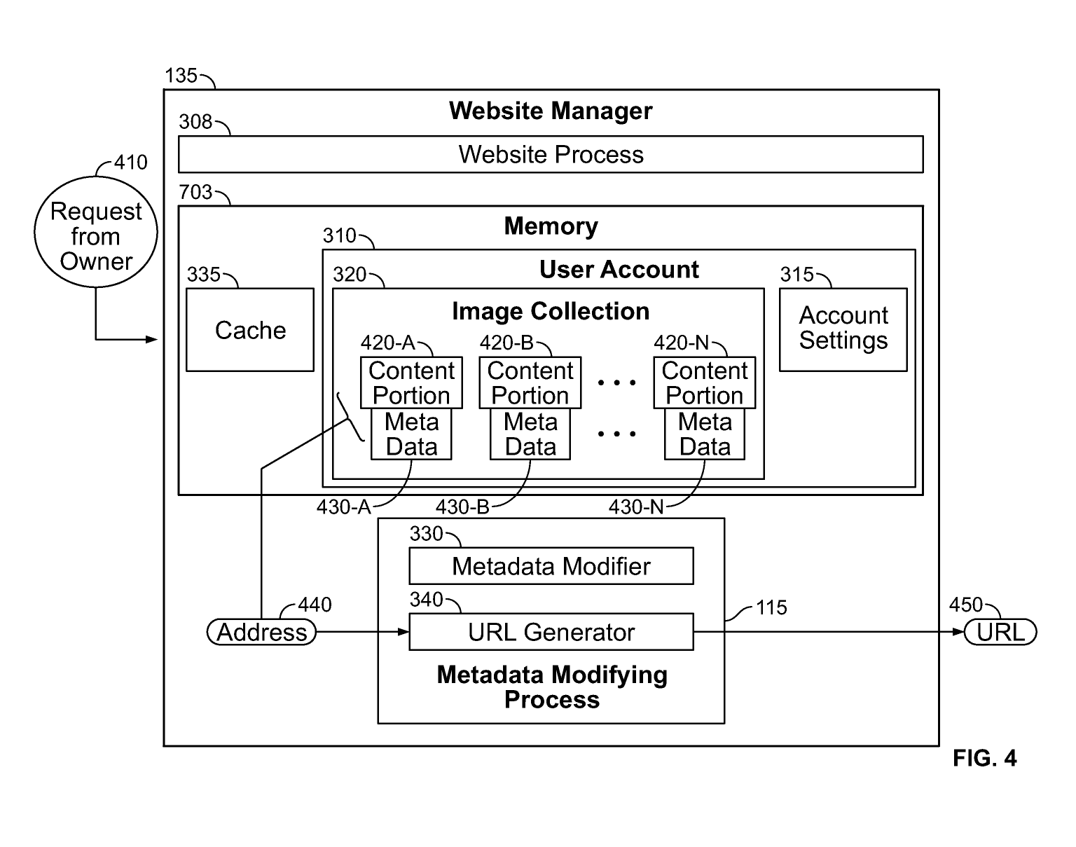

FIG. 4 shows a scenario for generating a URL that provides access to the content and the metadata provided to the owner of the content in accordance with an embodiment. The user account 310 contains multiple portions of content 420-A, 420-B . . . , 420-N in the content collection 320, which were uploaded to the website manager 135 by the owner of the user account 310. Each portion of content 420-A, 420-B . . . , 420-N includes corresponding metadata 430-A, 430-B . . . , 430-N Each portion of content 420 can be any type of digital media, such as, for example, a text file(s), an image(s), an audio file(s) and/or video file(s). Such metadata 430 can be any kind of information, such as information related to the owner of the user account 310 and/or information related to the corresponding portion of content 420. It is understood that each portion of content 420-A, 420-B . . . , 420-N can be located in a file (or in respective files) in the user account 310 along with the corresponding metadata 430-A, 430-B . . . , 430-N.

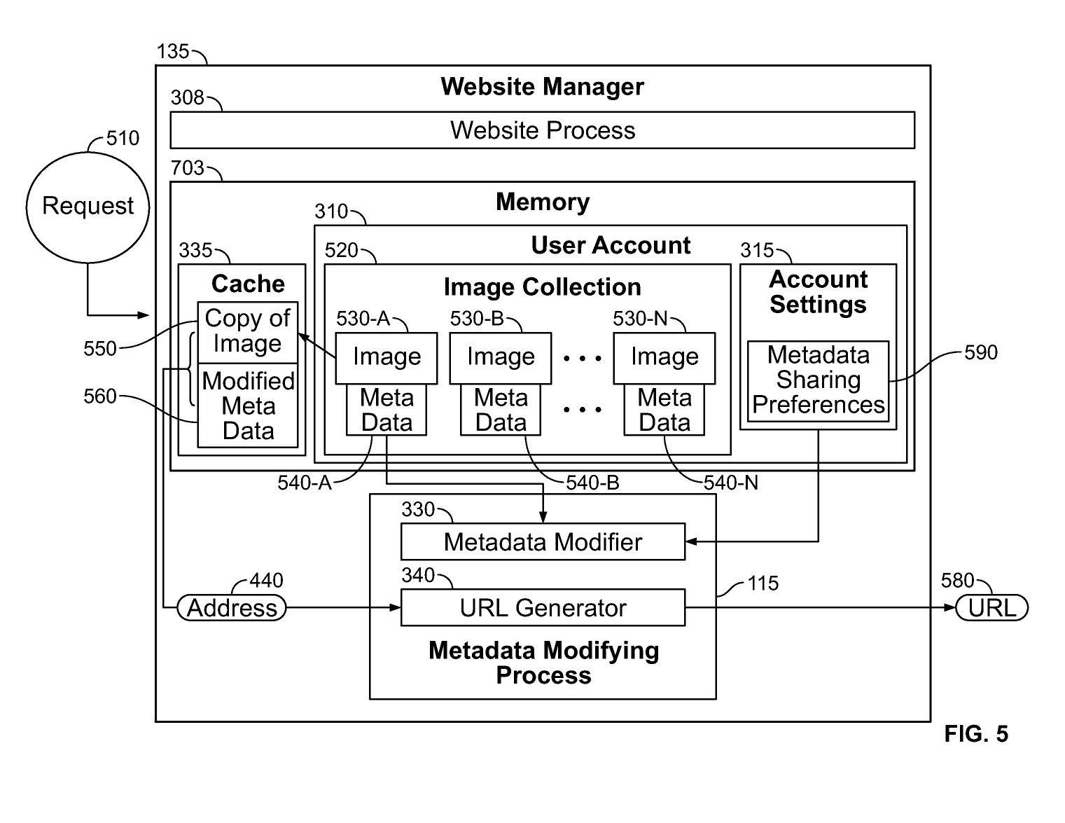

The owner of the user account 310 establishes metadata sharing preferences (illustrated in FIG. 5) for the portions of content 420 uploaded onto user account 310. The metadata sharing preferences indicate which portion(s) or type(s) of metadata 430 should be accessible to other users and which portion(s) or type(s) of metadata 430 should only be accessible to the owner of the account 310.

In the illustrative embodiment of FIG. 4, the metadata modifying process 115 receives a request 410 submitted from a user device 160 to access a particular portion of content 420-A in the content collection 320. The user device 160, for purposes of FIG. 4, is associated with the owner of the user account 310, who thereby is also the owner of the requested portion of content 420-A. Therefore, the request 410 is a request from the owner of the requested portion of content 420-A to access the particular portion of content 420-A in the content collection 320. The metadata modifying process 115 determines that the request 410 is associated with (e.g. sent by) the owner of the requested portion of content 420-A. The metadata modifying process 115 determines the address 440 of the requested portion of content 420-A in the content collection 320. The URL generator 340 processes the address 440 of the requested portion of content 420-A in order to create a secure (i.e. tamper-proof) URL 450 designated for the owner of the user account 310. In one embodiment, the URL 450 is specifically designated to be utilized by only the owner of the user account 310. The metadata modifying process 115 sends the URL 450 to the user device 160 associated with the owner of the user account 310 (i.e. the owner of the requested portion of content 420-A). The URL 450 provides the owner of the user account 310 with access to the requested portion of content 420-A as well as access to the content's 420-A metadata 420-B.

FIG. 5 shows a scenario for generating a URL that provides access to an image copy having modified metadata provided to a source other than the owner of an image in accordance with an embodiment. The user account 310 includes an image collection 520. The image collection 520 includes multiple images 530-A, 530-B . . . , 530-N, which were uploaded to the website manager 135 by the owner of the user account 310. Each image 530-A, 530-B . . . , 530-N contains (i.e. is associated with) corresponding metadata 540-A, 540-B . . . , 540-N. Such metadata 540 can be any kind of information, such as information related to the owner of the user account 310 and/or information related to the corresponding image 530 (such as an image geocode). Examples of metadata 540 include, but are not limited to, the name, address, phone number, email address, homepage and description of the owner of the user account 310 as well as characteristics of an respective image 530, such as a geocode, format, size, date of creation, date of modification and image effect settings.

In the illustrative embodiment of FIG. 5, the metadata modifying process 115 receives a request 510 submitted from a user device 160. The user device 160, for purposes of FIG. 5, is associated with a source other than the owner of the user account 310, who is also the owner of the respective images 530-A, 530-B . . . , 530-N in the image collection 520. Therefore, the request 510 is a request, made by a source other than the owner of any of the images in the image collection 520, to access a particular image 530-A in the image collection 520.

Since the request 510 is sent from a source other than the owner of the particular image 530-A, the metadata modifying process 115 will provide the source of the request 510 with access to a copy 550 of the requested image 530-A that has metadata that is generated in accordance with metadata sharing preferences 590 included in the owner's account settings 315. As previously described, the metadata sharing preferences 590 indicate which portion(s) or type(s) of metadata 540 should be accessible to other users and which portion(s) or type(s) of metadata 540 should only be accessible to the owner of the account 310 (i.e. the owner of the respective image 530). In some embodiments, the metadata sharing preferences 590 can be different according to the identity of a specific user(s) who is seeking access to a particular image. The metadata sharing preferences 590 can be different according to which particular image(s) 530 is being requested as well.

The metadata modifying process 115 generates a copy 550 of the requested image 530-A and places the image copy 550 in cache 335. The metadata modifying process 115, via the metadata modifier 330, processes the requested image's 530-A metadata 540-A in accordance with the metadata sharing preferences 590 in order to create modified metadata 560 for the image copy 550. For example, in one embodiment, the metadata modifier 330 prevents at least a portion of the requested image's 530-A metadata 540-A from being included in the modified metadata 560 for the image copy 550. Thus, when the source of the request 510 accesses the image copy 550, the source of the request 510 will only be able to access the image copy's 550 modified metadata 560—as opposed to having full access to the requested image's 530-A actual metadata 540-A.

The metadata modifying process 115 places the modified metadata 560 in cache 335 with the image copy 550. The metadata modifying process 115 determines the address 570 of the image copy 550 in the cache 335. The URL generator processes the address 570 of the image copy 550 in order to create a secure (i.e. tamper-proof) URL 580 designated for the source of the request 510. In one embodiment, the URL 580 is specifically designated to be utilized by only the source of the request 510. The metadata modifying process 115 sends the URL 580 to a user device 160 associated with the source of the request 510. The URL 580 provides the source of the request 510 with access to the image copy 550 which includes the modified metadata 560—thereby keeping the requested image's 530-A metadata 540-A accessible to only the owner of the account 310.

In one embodiment, the metadata modifying process 115 receives a second request from a second source to access the same image 530-A. The second source of the second request is different from both the source of the earlier request 510 and the owner of the image 530-A. The metadata modifying process 115 determines that the second source is different from both the source of the earlier request 510 and the owner of the image 530-A. The URL generator 340 processes the address 570 of the image copy 550 already in cache 335 in order to create a secure (i.e. tamper-proof) second URL designated for the second source of the second request. The metadata modifying process 115 sends the second URL to a user device 160 associated with the second source of the second request.

In yet another embodiment, the website manager 135 receives an updated metadata sharing preference specified by the owner of the user account 310. The metadata modifying process 115 determines that the modified metadata 560 already in the cache 335 with the image copy 550 is incompatible with the updated metadata sharing preference. Based on the determined incompatibility, the metadata modifying process 115 prohibits the first source of the request 510 and the second source of the second request from having access to the image copy 550 and the modified metadata 560 in cache 335 via the previously sent URL 580 and second URL. The metadata modifying process 115 also removes the image copy 550 and the modified metadata 560 from the cache 335.

In accordance with the updated metadata sharing preference, the metadata modifying process 115 modifies the metadata 540-A of the image 530-A to generate new modified metadata for a new copy of the image 530-A. The metadata modifying process 115 places the new copy of the image 530-A and the new modified metadata in cache 335. The URL generator 340 creates new tamper-proof URLs based on the address, in cache 335, of the new copy of the image 530-A. The metadata modifying process 115, via the URL generator 340, sends a new tamper-proof URL for accessing the new copy of the image 530-A to both the source of the request 510 and the second source of the second request.

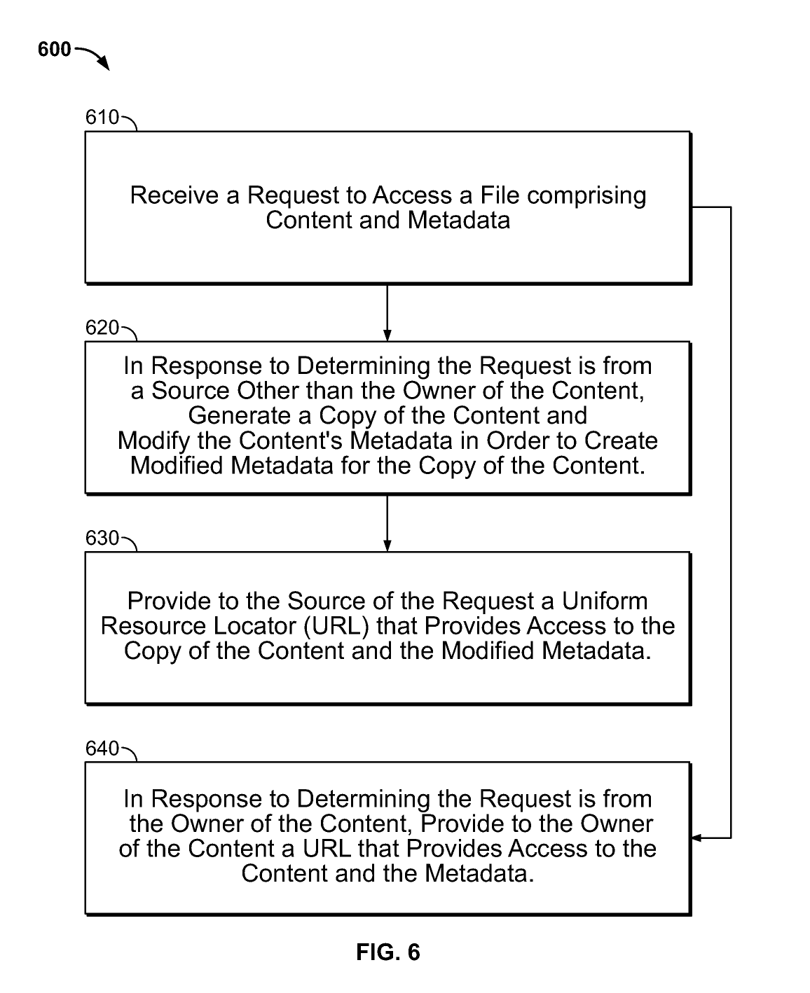

FIG. 6 is a flowchart 600 of a method of modifying metadata in accordance with an embodiment.

At step 610, a request to access content and metadata is received. The request can be received from the owner of the content or from a source other than the owner of the content. In various embodiments, the website manager 135 receives the request to access the content and the request may be processed at least by the metadata modifying process 115. It is understood that, in some embodiments, the request can be a request to access a file(s) comprising the content and the metadata.

At step 620, in response to the metadata modifying process 115 determining the request is from a source other than the owner of the content, a copy of the content (such as a copy of an image 550) is generated by the metadata modifying process 115 and the content's metadata is modified by the metadata modifying process 115 in order to create modified metadata for the copy of the content. The copy of the content is placed in cache by the metadata modifying process 115. The modified metadata is placed in the cache with the copy of the content by the metadata modifying process 115.

At step 630, a Uniform Resource Locator (URL) that provides access to the copy of the content (such as image copy 550) having the modified metadata is provided to the source of the request by the URL generator 340. The source of the request will thereby be able to access the copy of the content and the modified metadata, as opposed to having access to the content's actual metadata.

However, at step 640, in response to the metadata modifying process 115 determining the request is from the owner of the content, a URL, generated by the URL generator 340, that provides access to the content and the metadata is provided to the owner of the content.

In various embodiments, the method steps described herein, including the method steps described in FIG. 6, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 6. Certain steps of the methods described herein, including one or more of the steps of FIG. 6, may be performed by a server or by another processor in a network-based cloud-computing system. Certain steps of the methods described herein, including one or more of the steps of FIG. 6, may be performed by a client computer in a network-based cloud computing system. The steps of the methods described herein, including one or more of the steps of FIG. 6, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 7. Computer 700 includes a processor 701 operatively coupled to a data storage device 702 and a memory 703. Processor 701 controls the overall operation of computer 700 by executing computer program instructions that define such operations. The computer program instructions may be stored in data storage device 702, or other computer readable medium, and loaded into memory 703 when execution of the computer program instructions is desired. Thus, the method steps of FIG. 6 can be defined by the computer program instructions stored in memory 703 and/or data storage device 702 and controlled by the processor 701 executing the computer program instructions. For example, the computer program instructions can be implemented as computer executable code programmed by one skilled in the art to perform an algorithm defined by the method steps of FIG. 6. Accordingly, by executing the computer program instructions, the processor 701 executes an algorithm defined by the method steps of FIG. 6. Computer 700 also includes one or more network interfaces 704 for communicating with other devices via a network. Computer 700 also includes one or more input/output devices 705 that enable user interaction with computer 700 (e.g., display, keyboard, mouse, speakers, buttons, etc.).

Processor 701 may include both general and special purpose microprocessors, and may be the sole processor or one of multiple processors of computer 700. Processor 701 may include one or more central processing units (CPUs), for example. Processor 701, data storage device 702, and/or memory 703 may include, be supplemented by, or incorporated in, one or more application-specific integrated circuits (ASICs) and/or one or more field programmable gate arrays (FPGAs).

Data storage device 702 and memory 703 each include a tangible non-transitory computer readable storage medium. Data storage device 702, and memory 703, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 705 may include peripherals, such as a printer, scanner, display screen, etc. For example, input/output devices 705 may include a display device such as a cathode ray tube (CRT) or liquid crystal display (LCD) monitor for displaying information to the user, a keyboard, and a pointing device such as a mouse or a trackball by which the user can provide input to computer 700.

Any or all of the systems and apparatus discussed herein, including website manager 135, user device 160, and components thereof, including browser 210, display 270, website process 308, metadata modifying process 115 and memory 345 may be implemented using a computer such as computer 700.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for modifying metadata, comprising:
receiving a request to access a file comprising content and metadata;
in response to determining the request is from a first source other than an owner of the content:
generating a copy of the content;
modifying the metadata to create modified metadata for the copy of the content; and
providing to the first source of the request a Uniform Resource Locator (URL) that provides access to the copy of the content and the modified metadata.

2. The method as in claim 1, further comprising:
in response to determining the request is from the owner of the content, providing the owner of the content with a URL that provides access to the content and the metadata.

3. The method as in claim 1, wherein modifying the metadata to create modified metadata for the copy of the content comprises:
preventing at least a portion of the metadata of the content from being included in metadata for the copy of the content.

4. The method as in claim 3, wherein preventing at least a portion of the metadata of the content from being included in metadata for the copy of the content comprises:
preventing at least a portion of metadata of an image from being included in metadata for a copy of the image.

5. The method as in claim 4, wherein preventing at least a portion of the metadata of an image from being included in metadata for a copy of the image includes:
preventing at least one geocode in the metadata of the image from being included in the metadata of the copy of the image.

6. The method as in claim 1, wherein providing to the first source of the request the URL that provides access to the copy of the content and the modified metadata comprises:
providing the first source of the request with a first tamper-proof URL referencing the copy of the content, having the modified metadata, stored in a cache.

7. The method as in claim 6, further comprising:
receiving a request to access the content from a second source, the second source different than the first source;
in response to determining the second source is different than the owner of the image, providing the second source with a second tamper-proof URL that provides access to the copy of the content, having the modified metadata, stored in the cache.

8. The method as in claim 1, wherein modifying the metadata to create modified metadata for the copy of the content comprises:
modifying the metadata in accordance with a metadata sharing preference specified by the owner of the content.

9. The method as in claim 8, further comprising:
receiving an updated metadata sharing preference specified by the owner of the image;
prohibiting the first source of the request from having access to the copy of the content in response to determining at least a portion of the modified metadata for the copy of the content is incompatible with the updated metadata sharing preference;
in accordance with the updated metadata sharing preference, modifying the metadata of the content to generate new modified metadata for a new copy of the content; and
providing the first source of the request a new Uniform Resource Locator (URL) that provides access to the new copy of the content and the new modified metadata.

10. A non-transitory computer readable medium having program instructions stored thereon, that in response to execution by a computing device cause the computing device to perform operations comprising:
receiving a request to access a file comprising content and metadata;
in response to determining the request is from a first source other than an owner of the content:
generating a copy of the content;
modifying the metadata to create modified metadata for the copy of the content; and
providing to the first source of the request a Uniform Resource Locator (URL) that provides access to the copy of the content and the modified metadata.

11. The non-transitory computer readable medium of claim 10, further comprising at least one instruction defining the step of:
in response to determining the request is from the owner of the content, providing the owner of the content with a URL that provides access to the content and the metadata.

12. The non-transitory computer readable medium of claim 10, wherein the instructions defining the step of modifying the metadata to create modified metadata for the copy of the content comprises at least one instruction defining the step of:
preventing at least a portion of the metadata of the content from being included in metadata for the copy of the content.

13. The non-transitory computer readable medium of claim 12, wherein the instructions defining the step of preventing at least a portion of the metadata of the content from being included in metadata for the copy of the content comprises at least one instruction defining the step of:
preventing at least a portion of metadata of an image from being included in metadata for a copy of the image.

14. The non-transitory computer readable medium of claim 13, wherein the instructions defining the step of preventing at least a portion of the metadata of an image from being included in metadata for a copy of the image comprises at least one instruction defining the step of:
preventing at least one geocode in the metadata of the image from being included in the metadata of the copy of the image.

15. The non-transitory computer readable medium of claim 10, wherein the instructions defining the step of providing to the first source of the request the URL that provides access to the copy of the content and the modified metadata comprises at least one instruction defining the step of:
providing the first source of the request with a first tamper-proof URL referencing the copy of the content, having the modified metadata, stored in a cache.

16. The non-transitory computer readable medium of claim 15, further comprising at least one instruction defining the steps of:
receiving a request to access the content from a second source, the second source different than the first source;
in response to determining the second source is different than the owner of the image, providing the second source with a second tamper-proof URL that provides access to the copy of the content, having the modified metadata, stored in the cache.

17. The non-transitory computer readable medium of claim 10, wherein the instructions defining the step of modifying the metadata to create modified metadata for the copy of the content comprises at least one instruction defining the step of:
modifying the metadata in accordance with a metadata sharing preference specified by the owner of the content.

18. The non-transitory computer readable medium of claim 17, further comprising at least one instruction defining the steps of:
receiving an updated metadata sharing preference specified by the owner of the image;
prohibiting the first source of the request from having access to the copy of the content in response to determining at least a portion of the modified metadata for the copy of the content is incompatible with the updated metadata sharing preference;
in accordance with the updated metadata sharing preference, modifying the metadata of the content to generate new modified metadata for a new copy of the content; and
providing the first source of the request a new Uniform Resource Locator (URL) that provides access to the new copy of the content and the new modified metadata.

19. An apparatus, having a processor and a memory, configured to control:
a receiving module to receive a request to access a file comprising content and metadata;
a copy module to generate a copy of the content in response to determining the request is from a first source other than an owner of the content;
a metadata modification module to modify the metadata to create modified metadata for the copy of the content; and
a Uniform Resource Locator (URL) generator to provide to the first source of the request a URL that provides access to the copy of the content and the modified metadata.

20. The apparatus of claim 19 further comprising:
the URL generator to provide the owner of the content a URL that provides access to the content and the metadata.
